(19) United States
(12) Patent Application Publication
(10) Pub. No.: US 2026/0331390 A1
(43) Pub. Date: Oct. 22, 2026

(54) SLIDING CONTACT DEVICE FOR CONTACTING A MOVABLE ARCING CONTACT OF A VACUUM SWITCH

(71) Applicant: Siemens Energy Global GmbH & Co. KG, München (DE)

(72) Inventors: Volker Lehmann, Treuenbrietzen (DE); Martin Krehnke, Berlin (DE); Michael Bartz, Berlin (DE); Katrin Benkert, Schwaig (DE); Thomas Chyla, Berlin (DE); Oliver Duwe, Beetzsee O.T. Brielow (DE); Alexander Hartung, Berlin (DE); Henry Jenichen, Berlin (DE); Thomas Krull, Berlin (DE); Friedrich Löbner, Berlin (DE)

(21) Appl. No.: 19/115,903

(22) PCT Filed: Sep. 5, 2023
(86) PCT No.: PCT/EP2023/074298

§ 371 Date: Mar. 27, 2025

(30) Foreign Application Priority Data
Sep. 27, 2022 (DE) 10 2022 210 204.5

(51) Int. Cl. H01H 1/58; H01H 1/02; H01H 1/027; H01H 33/66; H01H 33/664

(52) U.S. Cl. CPC H01H 1/5833; H01H 1/0206; H01H 1/027; H01H 33/6606; H01H 33/664

(57) ABSTRACT

A sliding contact device is provided for contacting a movable arcing contact of a vacuum switch under high-voltage conditions. The sliding contact device includes an arcing contact movable along its longitudinal axis as well as a stationary counter contact. The sliding contact device is distinguished by low moving masses and low contact resistances.

The invention relates to contacting an axially movable arcing contact with a stationary hollow contact tube of a vacuum switch.

So far, in vacuum switches, contacting between the movable arcing contact and the stationary contact tube has been implemented by means of a clamped socket onto which a contact ring is screwed that additionally includes a rib band contact. The design-related large amount of contacts results in a high contact resistance which is disadvantageous for the thermal load capacity of the vacuum switch. Also, the high mass of this design needs to be accelerated to the high contact speed required. This results in increased mechanical loads of the kinematic chain; correspondingly high drive energies are also required.

Another known solution employs a conductor line. As with high voltage levels, such as high-voltage, higher contact speeds are required, this solution is also subjected to high mechanical loads.

The object of the invention is to implement the contact between the movable arcing contact of the vacuum tube and the stationary contact tube of the vacuum switch in such a manner that allows for reliably contacting the movable arcing contact at low moving masses and low contact resistance.

The object is achieved by a sliding contact device for contacting a movable arcing contact of a vacuum switch comprising the features of claim 1, claim 3, and claim 6.

Advantageously, the suggested solutions are characterized by low moving masses and low contact resistances.

Advantageous further developments of the invention are indicated in the dependent claims.

The invention will be explained below as an exemplary embodiment in greater detail to the extent required for understanding the same by means of Figures.

In the Figures:

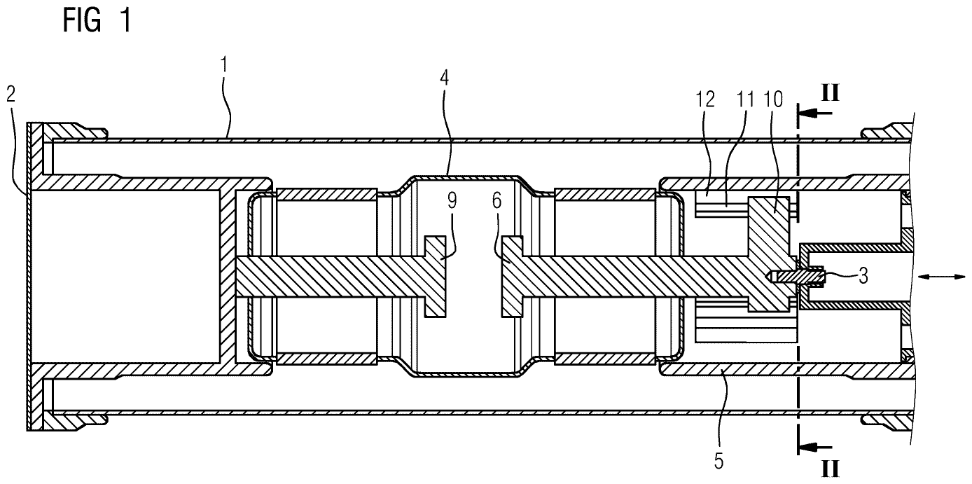

FIG. 1 shows a first contact of an axially movable arcing contact of a vacuum switch according to the invention,

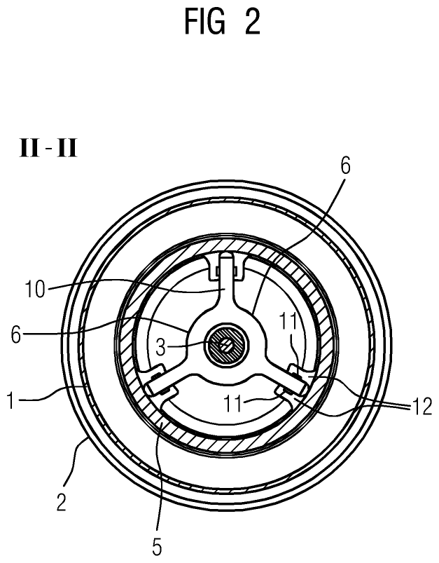

FIG. 2 shows a section of the assembly of FIG. 1 taken along sectional plane II-II,

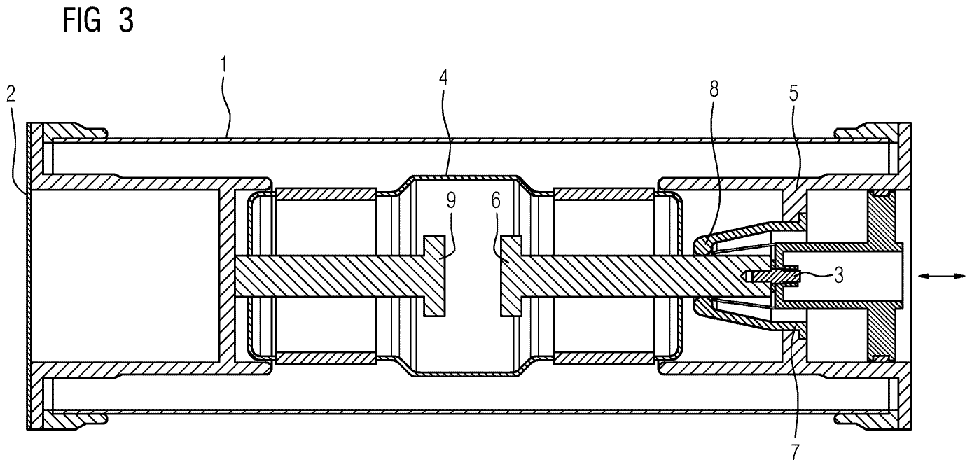

FIG. 3 shows a second contact of an axially movable arcing contact of a vacuum switch according to the invention,

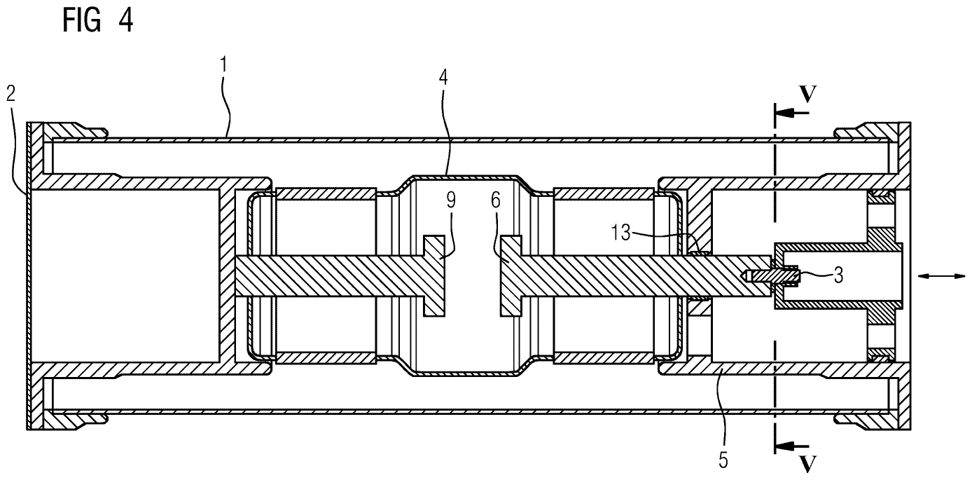

FIG. 4 shows a third contact of an axially movable arcing contact of a vacuum switch according to the invention, and

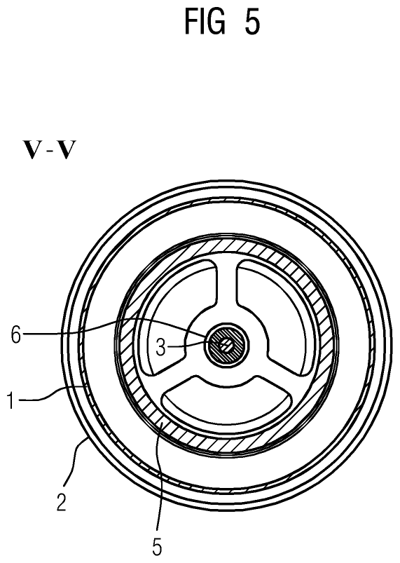

FIG. 5 shows a section of the assembly of FIG. 4 taken along sectional plane V-V.

In the figures, same numerals indicate same elements.

In the exemplary embodiment of FIG. 1, electrically conductive fins 10 (three fins, for example) are attached to the movable arcing contact 6 of the vacuum tube 4, running in corresponding contact grooves of the counter contact. For example, a contact groove may be formed in the stationary hollow contact tube 5 by two conductive flanges 12 which are provided with electrically conductive rib contacts 11 at the inner contact surfaces. The arcing current then flows to the rib contacts 11 via the fins 10 of the movable arcing contact 6 and then to the electrically conductive flanges of the stationary contact tube 5 (counter contact).

The exemplary embodiment of FIG. 3 shows a tubular contact element 7 having resilient contact fingers 8. The contact element coaxially encompasses the movable arcing contact 6 of the vacuum tube and is galvanically fixed to the stationary contact tube 5. Preferably, it is made of CuCr1Zr or carbon-fiber reinforced carbon.

In the exemplary embodiment of FIG. 4, the movable arcing contact 6 of the vacuum tube 4 is electrically connected to the stationary contact tube 5 by means of a rib contact band 13. Here, the rib contact band 13 is fixedly secured in a ring and is connected to the stationary contact tube 5, e.g., by means of flanges or nibs. The sliding contact is provided between the rib contact band 13 and the movable arcing contact 6. In this solution, implementing the contact tube as a cast component is particularly cost-effective.

The movable arcing contact 6 is driven and centrally guided via a follower 3.

The sliding contact device according to the invention may be configured for high voltage. As used herein, high voltage means a voltage of 72.5 kilo Volts and more.

The present invention has been explained in detail using particular exemplary embodiments for illustrative purposes. Elements of the individual exemplary embodiments may also be combined with each other. Therefore, the invention is not intended to be limited to individual exemplary embodiments, but it should be limited by the appended claims only.

### REFERENCE NUMERALS

1 Isolating housing
2 Stationary contact element, first high-voltage terminal
3 Follower, driver
4 Vacuum switching tube
5 Stationary hollow contact tube, second high-voltage terminal
6 Axially movable arcing contact of the vacuum switching tube
7 Tubular contact element
8 Resilient contact finger
9 Stationary arcing contact of the vacuum switching tube
10 Electrically conductive fin
11 Electrically conductive rib contact
12 Flanges
13 Rib contact band
II-II Sectional plane
V-V Sectional plane

1-9. (canceled)

10. A sliding contact device of a vacuum switch, the sliding contact device comprising:
an arcing contact having a longitudinal axis and being movable along said longitudinal axis, said arcing contact including a plurality of fins being equally spaced apart around said longitudinal axis; and
a stationary counter contact having flanges;
each of said fins cooperating with said flanges as a sliding contact.

11. The sliding contact device according to claim 10, wherein said plurality of fins includes three fins.

12. The sliding contact device according to claim 10, wherein each of said flanges is provided with a respective rib contact.

13. The sliding contact device according to claim 10, wherein said stationary counter contact is a cast component

14. A sliding contact device of a vacuum switch, the sliding contact device comprising:
an arcing contact having a longitudinal axis and being movable along said longitudinal axis;
a stationary counter contact;
a tubular contact element galvanically fixed to said stationary counter contact;
said tubular contact element having resilient contact fingers coaxially encompassing said movable arcing contact and causing the tubular contact element and said movable arcing contact to cooperate as a sliding contact.

15. The sliding contact device according to claim 14, wherein said tubular contact element is made of CuCr1Zr.

16. The sliding contact device according to claim 14, wherein said tubular contact element is made of carbon-fiber reinforced carbon.

17. The sliding contact device according to claim 14, wherein said stationary counter contact is a cast component

18. A sliding contact device of a vacuum switch, the sliding contact device comprising:
an arcing contact having a longitudinal axis and being movable along said longitudinal axis;
a stationary counter contact; and
a rib contact band formed in a ring being concentric with said longitudinal axis of said movable arcing contact, said rib contact band being connected to said stationary counter contact and causing said rib contact band and said movable arcing contact to cooperate as a sliding contact.

19. The sliding contact device according to claim 18, which further comprises nibs connecting said rib contact band to said stationary counter contact.

20. The sliding contact device according to claim 18, wherein the rib contact band is arranged in a groove of said stationary counter contact.

21. The sliding contact device according to claim 18, wherein said stationary counter contact is a cast component.
